(19) United States
(12) Patent Application Publication
(10) Pub. No.: US 2025/0276873 A1
(43) Pub. Date: Sep. 4, 2025

(54) ROPE TENSIONING DEVICE FOR AN OVERSPEED GOVERNOR OF AN ELEVATOR AND AN ELEVATOR COMPRISING SUCH A ROPE TENSIONING DEVICE

(71) Applicant: WITTUR Holding GmbH, Wiedenzhausen, Bayern (DE)

(72) Inventors: René Holzer, Scheibbs (AT); Alfred Kalkus, St. Anton/Jeßnitz (AT); Karl Kriener, Viehdorf (AT); Leopold Latschbacher, Neustadtl/Donau (AT)

(73) Assignee: WITTUR Holding GmbH, Wiedenzhausen, Bayern (DE)

(21) Appl. No.: 18/855,812

(22) PCT Filed: Nov. 17, 2023
(86) PCT No.: PCT/IB2023/061639

§ 371 Date: Oct. 10, 2024

(30) Foreign Application Priority Data
Nov. 24, 2022 (IT) 102022000024261

(51) Int. Cl. B66B 5/04; B66B 7/06

(52) U.S. Cl. CPC B66B 5/044; B66B 7/06

(57) ABSTRACT

A rope tensioning device for an overspeed governor of an elevator, including a pulley; a lever arm hinged to the pulley; a fixed support member, to which one end of the lever arm is hinged; two extension springs arranged in parallel; a first connecting member mounted on the fixed support member and a second connecting member mounted on the lever arm, each extension spring having one end connected to the first connecting member and the other one to the second connecting member, at least one of the first and second connecting members is mounted so as to be tiltable around a hinge axis, said at least one tiltable connecting member being held in a predetermined working position by the two extension springs; means for detecting a tilt of said at least one tiltable connecting member beyond a predetermined angle with respect to its working position.

### TECHNICAL FIELD

The present invention relates to a rope tensioning device for an overspeed governor of an elevator and an elevator comprising such a rope tensioning device.

The European directive EN 81 20/50 requires the use of an overspeed governor on ropeways. The overspeed governor is the safety device that is activated if the speed of the lift is exceeded, ensuring the safety of people inside. If the lift car exceeds its nominal speed during the ascent or descent, the overspeed governor engages and triggers a safety gear on the governor's rope.

### BACKGROUND ART

It is known the use of a tension weight to tension the rope loop of the overspeed governor of an elevator by gravity force. Due to problems related to material cost and handling of the weight, spring loaded tension devices have begun to spread in the market. In particular, a solution with two guided compression springs have been developed in the recent years. However, this solution is complex because it requires a guidance for the springs. Moreover, the compression springs cannot be produced with pretension force.

The use of extension springs in this context is considered unsafe as of now because if the extension spring fails, no force at all is generated, whereas the broken compression spring still generates a reduced force. Document CN 101 078 429 B discloses a tightener of spring speed limit device, comprising tightening pulley, tightening pulley arm and tightening pulley support. The tightening pulley is connected with the tightening pulley arm in rotation and the tightening pulley arm is connected with fixed tightening pulley support in rotation. It is characterized in that spring is set between the tightening pulley arm and the tightening pulley support; one end of the spring is connected with the tightening pulley support and the other end is connected with the tightening pulley arm; and the spring applies downward tightening force to the tightening pulley on the tightening pulley arm. At the same time, elastic adjusting device is set on said tightening pulley support to adjust spring elastic force. Compared with prior technology, the invention adopts spring to replace original big heavy block so as to decrease occupied space and save producing cost while the invention also adopts the elastic adjusting device to adjust spring elastic force freely so as to make the practical application range of tightener of spring speed limit device more flexible.

### DISCLOSURE OF THE INVENTION

In this context, the technical task underlying the present invention is to propose a rope tensioning device for an overspeed governor of an elevator and an elevator comprising such a rope tensioning device which overcome the drawbacks in the prior art as described above.

In particular, an object of the present invention is to provide a rope tensioning device for an overspeed governor of an elevator, which is safe as the previous solutions, but simpler and compact.

The stated technical task and specified objects are substantially achieved by a rope tensioning device for an overspeed governor of an elevator, comprising:
a pulley;
a lever arm hinged to the pulley;
a fixed support member, to which one end of the lever arm is hinged; two extension springs arranged in parallel;
a first connecting member mounted on the fixed support member and a second connecting member mounted on the lever arm, each extension spring having one end connected to the first connecting member and the other one to the second connecting member,
at least one of the first and second connecting members is mounted so as to be tiltable around a hinge axis, the tiltable connecting member being held in a predetermined working position by the two extension springs;
means for detecting a tilt of the tiltable connecting member beyond a predetermined angle with respect to its working position.

According to one embodiment, a hinge point of the tiltable connecting member is located at an intermediate portion of it, the corresponding ends of the extension springs are connected to opposite sides of the tiltable connecting member with respect to the hinge point.

According to one embodiment, the means for detecting comprises a switch which is activated when the tiltable connecting member is tilted beyond the predetermined angle with respect to its working position.

According to a first embodiment, the switch faces the tiltable connecting member so that it contacts the switch when it is tilted beyond the predetermined angle with respect to its working position.

According to one embodiment, the tiltable connecting member comprises a supporting portion to which the extensions springs are connected and tab protruding away from the supporting portion, said tiltable connecting member being hinged at the tab.

According to a second embodiment, the rope tensioning device comprises a leverage interposed between the switch and the tiltable connecting member. The tiltable connecting member brings the leverage to activate the switch when it is tilted beyond the predetermined angle with respect to its working position.

According to one embodiment, the leverage comprises a disk facing the tiltable connecting member. The tiltable connecting member is shaped in such a way to contact the disk when it is tilted beyond the predetermined angle with respect to its working position, bringing the leverage to activate the switch.

According to a third embodiment, the switch is mounted on the tiltable connecting member and the rope tensioning device comprises at least one abutting block which is fixed and arranged in such a way that the switch contacts it when the tiltable connecting member is tilted beyond the predetermined angle with respect to its working position.

According to one embodiment, the lever arm has an elongated development between a first end and a second end, said lever arm being hinged to the fixed support member at the first end and to the pulley at an intermediate portion between the first and second end.

According to one embodiment, the tiltable connecting member and the switch are mutually arranged in such a way that the switch is activated when the position of the pulley exceed from its working range.

According to one alternative embodiment, the rope tensioning device comprises a further switch facing the first end of the lever arm. The first end activates the further switch when the position of the pulley exceeds from its working range.

The stated technical task and specified objects are substantially achieved by an elevator, comprising:
an overspeed governor;
a rope tensioning device according to what is described;
means for interrupting the functioning of the elevator in response to the detection of a tilt of the tiltable connecting member beyond the predetermined angle with respect to its working position.

### BRIEF DESCRIPTION OF DRAWINGS

Additional features and advantages of the present invention will become more apparent from the non-limiting, description of a preferred, but non-exclusive embodiment of a rope tensioning device for an overspeed governor of an elevator and an elevator comprising such a rope tensioning device, as illustrated in the appended drawings, in which:

FIG. 1 illustrates a first embodiment of a rope tensioning device for an overspeed governor of an elevator, according to the present invention, in a frontal view;

FIG. 2 illustrates a detail (switch and tiltable connecting member) of the rope tensioning device of FIG. 1;

FIGS. 3-6 illustrate different spring failure situations for the rope tensioning device of FIG. 1, in a frontal view;

FIG. 7 illustrates a second embodiment of the rope tensioning device configured in a lowermost working position, in a frontal view;

FIG. 8 illustrates a detail (switch, leverage and tiltable connecting member) of the rope tensioning device of FIG. 7;

FIG. 9 illustrates a second embodiment of the rope tensioning device configured in an uppermost working position, in a frontal view;

FIG. 10 illustrates a detail (switch, leverage and tiltable connecting member) of the rope tensioning device of FIG. 9;

FIG. 11 illustrates a third embodiment of the rope tensioning device configured in a working position, in a frontal view;

FIG. 12 illustrates a detail (switch, tiltable connecting member and abutting blocks) of the rope tensioning device of FIG. 11;

FIG. 13 illustrates a perspective view of the detail of FIG. 12, in a configuration of failure of one extension spring.

### DETAILED DESCRIPTION OF PREFERRED EMBODIMENTS OF THE INVENTION

With reference to the figures, number 1 indicates a rope tensioning device for an overspeed governor of an elevator.

The rope tensioning device 1 comprises a pulley 2. The rope is destined to be mounted in a loop between the pulley 2 of the rope tensioning device 1 and on a pulley of the overspeed governor.

The rope tensioning device 1 comprises a lever arm 3 hinged to the pulley 2. Preferably, the lever arm 3 is hinged at an intermediate portion. Preferably, the pulley 2 is able to rotate around a central rotation axis. Preferably, the hinge axis of the lever arm 3 is substantially parallel to the central rotation axis of the pulley 2. Preferably, the two axes are coincident.

The rope tensioning device 1 comprises a fixed support member 4, to which one end of the lever arm 3 is hinged. As shown in figures, the fixed support member 4 is connectible to a guide rail of the elevator.

The rope tensioning device 1 comprises two extension springs 5 arranged in parallel and interposed between the fixed support member 4 and the lever arm 3.

The rope tensioning device 1 comprises a first connecting member 6 mounted on the fixed support member 4 and a second connecting member 7 mounted on the lever arm 3. One end of each extension springs 5 is connected to the first connecting member 6, while the other end of each extension springs 5 is connected to the second connecting member 7.

At least one of the first and second connecting members 6, 7 is mounted so as to be tiltable around a hinge axis X. The one of the first and second connecting members 6, 7 which is tiltable will be referred from now on as “the tiltable connecting member”.

In such a way, the extension springs 5 have one end connected to a tiltable (flexible) portion and when one extension spring 5 fails, the tension is lessened and the tiltable connecting member 6, 7 tilts.

In particular, the tiltable connecting member 6, 7 is held in a predetermined working position by the two extension springs 5. The working position is appropriately not a point of stable equilibrium for the tiltable connecting member 6, 7 so that when one extension springs 5 fails, it rotates around the hinge axis X in a new position.

There can be many ways of determining the working position and the angle assumed by the tiltable connecting member 6, 7 with respect to the working position. For example, the angle of rotation may be deduced by considering the inclination of an axis of symmetry with respect to a reference axis which identifies the working position.

Preferably, the hinge point of the tiltable connecting member 6, 7 is located at an intermediate portion of the tiltable connecting member 6, 7. The corresponding ends of the extension springs 5 are connected to opposite sides of the tiltable connecting member 6, 7 with respect to the hinge point. In this way, the direction of rotation (clockwise or anti-clockwise) of the tiltable connecting member 6, 7 depends on which one of the two extension springs 5 fails. This ensures that of the tiltable connecting member 6, 7 rotates to a position defined by an angle with respect to the working position that is greater than the predetermined angle and it is not restrained from rotating in that direction by the other extension spring 5.

The rope tensioning device 1 comprises means for detecting 8 the tilt of the tiltable connecting member 6, 7 beyond a predetermined angle with respect to its working position due to the failure of one of the extension springs 5. In particular, the tiltable connecting member 6, 7 rotates beyond its working range.

According to a preferred embodiment, the means for detecting 8 comprises a switch which is activated when the tiltable connecting member 6, 7 is tilted beyond the predetermined angle with respect to its working position. The activation of the switch leads to an opening of the safety circuit of the elevator, interrupting its functioning.

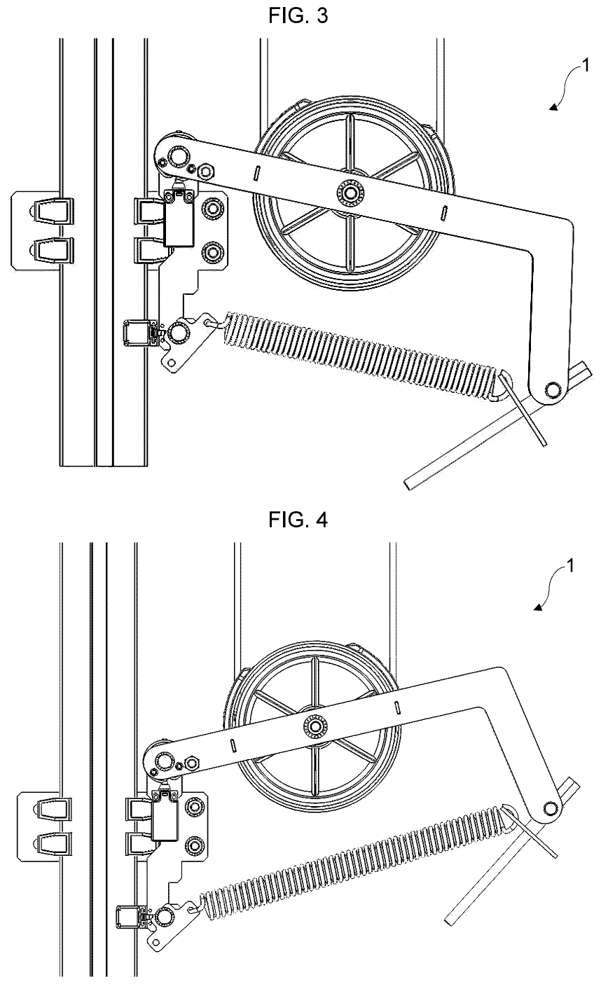

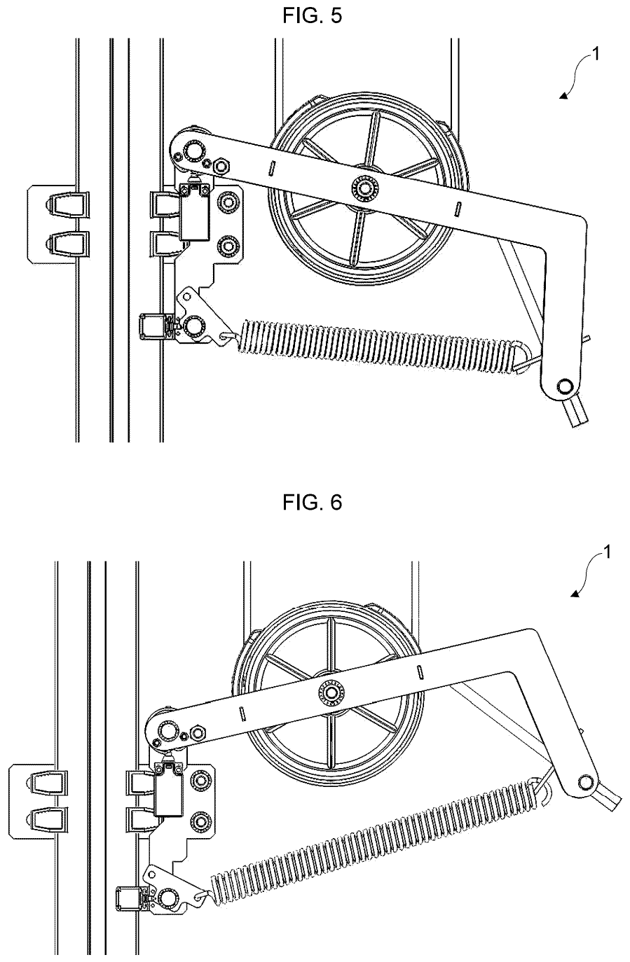

As shown in FIGS. 3-6, the failure of one of the extension springs 5 may cause the clockwise or anti-clockwise rotation of the tiltable connecting member 6, 7. In all such cases, the tiltable connecting member 6, 7 contacts the switch 8 ensuring that the failure of one of the extension springs 5 is always detected. In particular, the configuration illustrated shows an upper extension spring 5 and a lower extension spring 5. When the lower extension spring 5 fails (FIGS. 3 and 4), the tiltable connecting member 6, 7 rotates clockwise. When the upper extension spring fails (FIGS. 5 and 6), the tiltable connecting member 6, 7 rotates anti-clockwise.

The switch 8 detects the failure regardless of the sense of rotation of the bracket 5.

According to the illustrated embodiment, both the first and second connecting members 6, 7 are hinged respectively to the fixed support member 4 and to the lever arm 3, therefore they are both tiltable with respect to their working position. In this case, the tiltable connecting member to which reference is made in this application is the connecting member which is associated with the switch 8 to detect the spring failure.

Preferably, the first connecting member 6 is a bracket.

Preferably, the second connecting member 7 is a spring hinge plate or a spanner.

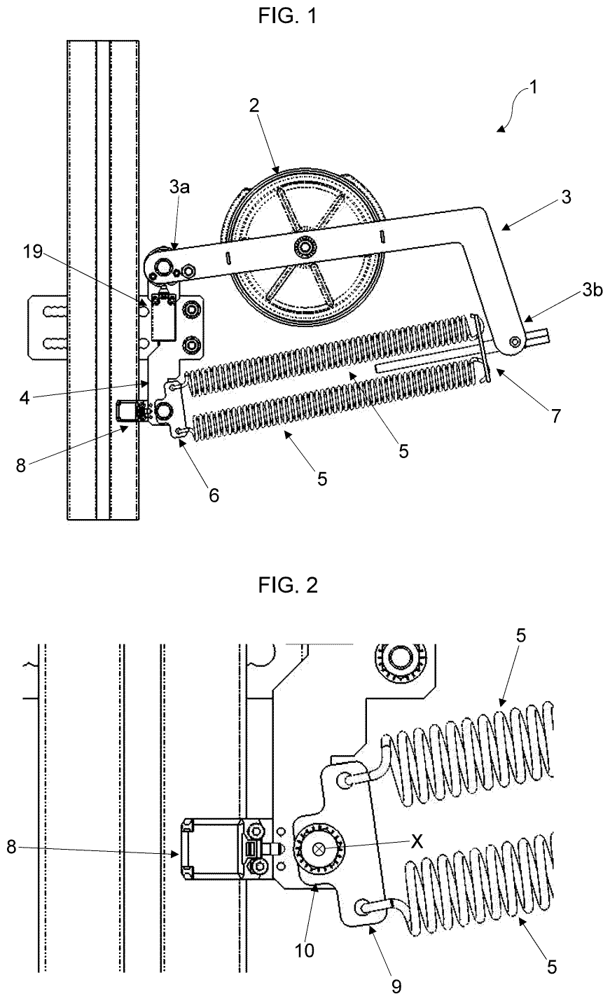

According to a first embodiment, illustrated in FIGS. 1-6, the switch 8 faces the tiltable connecting member 6, 7 and is arranged in such a way that the tiltable connecting member 6, 7 contacts the switch 8 when it is tilted beyond the predetermined angle with respect to its working position. In this embodiment, the tiltable connecting member 6, 7 directly activates the switch 8.

According to the preferred embodiment, the switch 8 is associated with the first connecting member 6, which is the tiltable connecting member. This allows for a simpler mounting. In this first embodiment, the switch 8 is mounted on the fixed support member 4.

Preferably, the first connecting member 6 comprises a supporting portion 9 to which the springs 5 are connected and a tab 10 protruding away from the supporting portion 9. The first connecting member 6 is hinged at the tab 10. Preferably, the supporting portion 9 and the tab 10 defines a T-shape.

The switch 8 faces the tab 10 and when one of the extension springs 5 fails, the tab 10 contacts the switch 8.

Preferably, the tab 10 comprises an inward portion shaped so as to define a recess. In the working position of the tiltable connecting member 6, 7, the switch 8 faces the recess. In this embodiment the switch 8 is put closer to the tiltable connecting member 6.

According to the preferred embodiment, the first connecting member 6 is a T-shaped plate.

FIGS. 3a and 4a show that in the lowest position of the working range the upper/lower springs 5 are failing. FIGS. 3b and 4b are similar but for the uppermost working position.

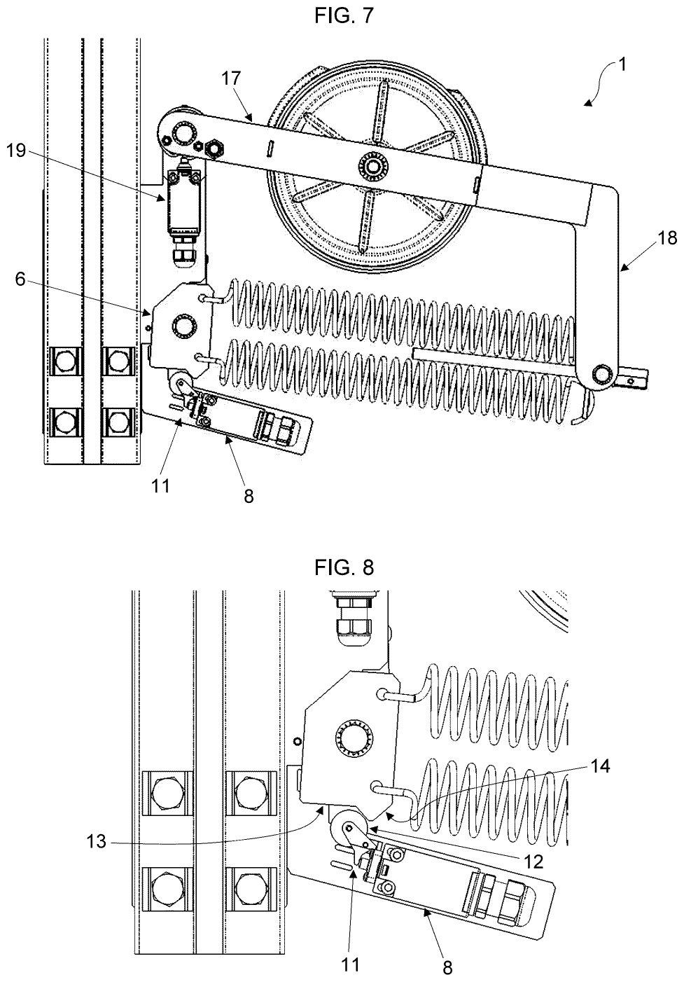

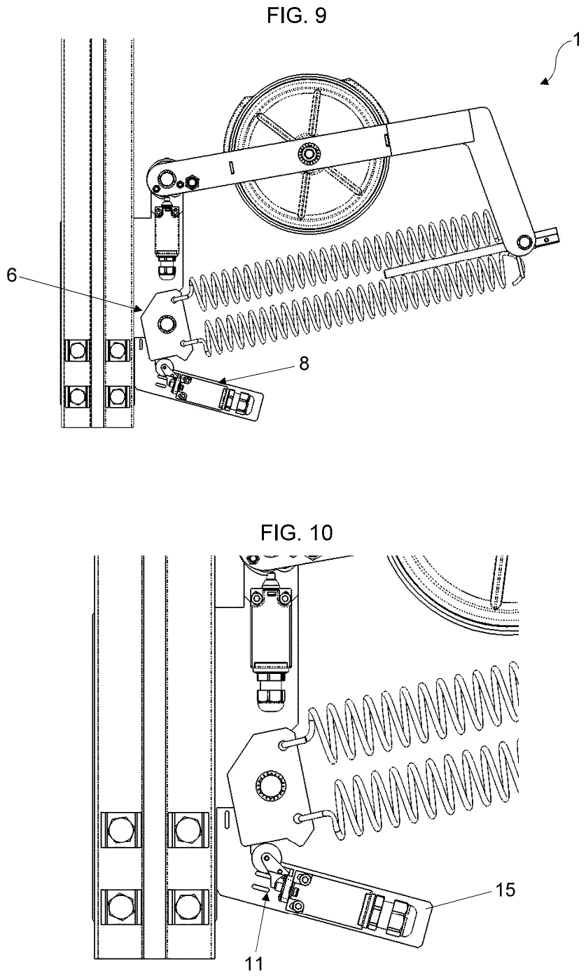

According to a second embodiment, illustrated in FIGS. 7-10, the rope tensioning device 1 comprises a leverage 11 interposed between the switch 8 and the tiltable connecting member 6, 7. When it is tilted beyond the predetermined angle with respect to its working position, the tiltable connecting member 6, 7 brings the leverage 11 to activate the switch 8. This solution was designed to overcome the small distance to the guide rail where is not enough space for the switch 8.

In particular, the tiltable connecting member 6, 7 contacts the leverage 11 when it is tilted beyond the predetermined angle with respect to its working position.

Preferably, the leverage 11 comprises a disk 12 facing the tiltable connecting member 6, 7. The tiltable connecting member 6, 7 is shaped so as to contact the disk 12 when it is tilted beyond the predetermined angle with respect to its working position. Preferably, the tiltable connecting member 6, 7 comprises two contacting zones 13, 14 which come in contact with the disk 12 when the tiltable connecting member 6, 7 is tilted beyond the predetermined angle respectively in both direction of rotation.

According to the illustrated embodiment, the two contacting zones are a flat surface 13 and a protuberance 14.

In this second embodiment, the tiltable connecting member 6, 7 indirectly activates the switch 8 via the leverage 11.

According to the preferred embodiment, the switch 8 is activated by the first connecting member 6, which is tiltable. The switch 8 is mounted on a further bracket 15 mounted on the fixed support member 4 and protruding from it.

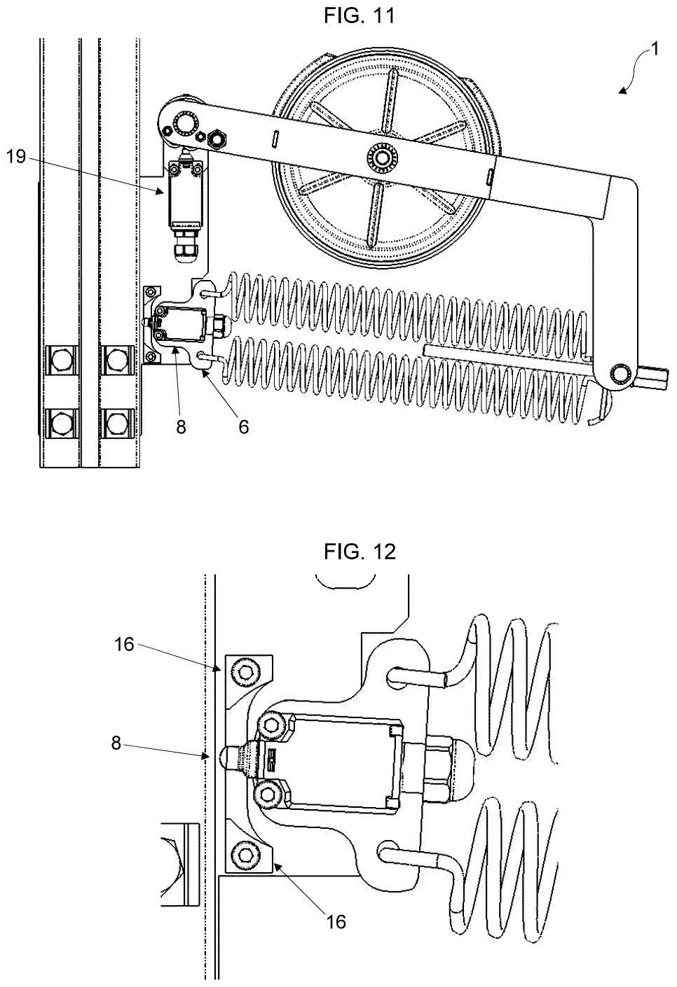

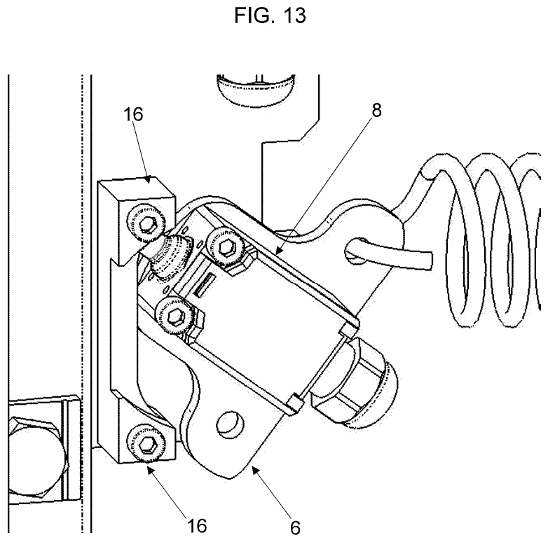

According to a third embodiment, illustrated in FIGS. 11-13, the switch 8 is mounted on the tiltable connecting member 6, 7. The rope tensioning device 1 comprises at least one abutting block 16 which is fixed and arranged so that the switch 8 contacts it when the tiltable connecting member 6, 7 is tilted beyond the predetermined angle with respect to its working position.

Preferably, the abutting blocks 16 are two and they are alternately contacted by the switch 8 whether the tiltable connecting member 6, 7 rotates clockwise or anti-clockwise.

According to the preferred embodiment, the switch 8 is mounted on the first connecting member 6, which is tiltable. The abutting block 16 is mounted on the fixed support member 4.

According to the embodiment here described and illustrated, the lever arm 3 has an elongated development between a first end 3a and a second end 3b. The lever arm 3 is hinged to the fixed support member 4 at the first end 3a and to the pulley 2 at an intermediate portion between the first and second end 3a, 3b. The second connecting member 7 is mounted at the second end 3b.

Preferably, the lever arm 3 comprises a first portion 17 developing along a first direction and a second portion 18 developing along a second direction. The second direction is inclined with respect to the first direction. The lever arm 3 is hinged to the pulley 2 at an intermediate portion of the first portion 17.

According to the preferred embodiment, the tiltable connecting member 6, 7 and the switch 8 are mutually arranged so that the switch 8 is activated as soon as the position of the pulley 2 (and therefore also the lever end 3b and the springs 5) are in a too low or too high position. A spring failure could generate a even bigger rotation of the tab ensuring switch 8 opening as well.

In this way, the configurations proposed are able to detect both correct pulley position (and therefore tension) and spring failure with one switch 8. This simplifies the structure of the device 1.

According to an alternative embodiment, the rope tensioning device 1 comprises a further switch 19 facing the first end 3a of the lever arm 3 and active on it. In this embodiment, the further switch 19 is dedicated to detect when the rope tension is not in the correct range, whereas the switch 8 is dedicated to detect spring failure. In particular, the further switch 19 acts to check if the pulley 2 position is in the working range. Exceeding the upper limit would result in too high spring force, being below the lower limit would result in too low spring force and therefore too low tension force.

In this embodiment, the further switch 19 can be of the self-resetting type, that is closing by itself after a short jumping of the tension pulley. The switch 8 instead is of the manual reset type to ensure a permanent open safety circuit after a spring failure.

In alternative, the switches 8, 19 are wired in a way that it can be seen via a controller or via remote monitoring if the tension force is out of working range or if a spring is broken.

An elevator is also object of the present invention.

The elevator comprises the rope tensioning device 1 according to what is described above.

The elevator comprises an overspeed governor comprising a pulley and a rope mounted in a loop between the pulley of the overspeed governor and the pulley 2 of the rope tensioning device 1.

The elevator comprises means for interrupting the functioning of the elevator in response to the detection of a tilt of the tiltable connecting member 6, 7 beyond the predetermined angle.

Preferably, the elevator comprises a safety circuit. The safety circuit comprises the switch 8 which puts the circuit open when activated

According to the embodiment with a further switch 19, the further switch 19 is arranged on the safety circuit in series with the switch 8.

The characteristics of the rope tensioning device for an overspeed governor of an elevator and the elevator comprising such a rope tensioning device, according to the present invention, emerge clearly from the above description, as do the advantages.

In particular, the presence of a tiltable member combined with the means for detecting its tilting beyond a predetermined angle allows to immediately recognize the lessening of the tension. The tiltable connecting member is directly connected to the springs, therefore the detection is immediate and unambiguous.

The first embodiment is to be preferred when there is enough room for the switch next to the guide rail because it is activated directly by the tiltable connecting member.

The second embodiment provides an alternative to be used when there is not enough room for the switch.

The third embodiment also minimizes the encumbrances next to the guide rail, arranging the switch on the tiltable connecting member.

1. A rope tensioning device (1) for an overspeed governor of an elevator, comprising:
a pulley (2);
a lever arm (3) hinged 5 to the pulley (2);
a fixed support member (4), to which one end (3a) of the lever arm (3) is hinged;
two extension springs (5) arranged in parallel;
a first connecting member (6) mounted on the fixed support member (4) and a second connecting member (7) mounted on the lever arm (3),
each extension spring (5) having one end connected to the first connecting member (6) and the other one to the second connecting member (7), at least one of the first and second connecting members (6, 7) is mounted so as to be tiltable around a hinge axis (X), said at least one tiltable connecting member (6, 7) being held in a predetermined working position by the two extension springs (5);
means for detecting (8) a tilt of said at least one tiltable connecting member (6, 7) beyond a predetermined angle with respect to its working position.

2. The rope tensioning device (1) according to claim 1, wherein a hinge point of said at least one tiltable connecting member (6, 7) is located at an intermediate portion of it, the corresponding ends of the extension springs (5) are connected to opposite sides of said at least one tiltable connecting member (6, 7) with respect to the hinge point.

3. The rope tensioning device (1) according to claim 1, wherein said means for detecting (8) comprises a switch which is activated when said at least one tiltable connecting member (6, 7) is tilted beyond the predetermined angle with respect to its working position.

4. The rope tensioning device (1) according to claim 3, wherein the switch (8) faces said at least one tiltable connecting member (6, 7) so that it contacts the switch (8) when it is tilted beyond the predetermined angle with respect to its working position.

5. The rope tensioning device (1) according to claim 4, wherein said at least one tiltable connecting member (6, 7) comprises a supporting portion (9) to which the extensions springs (5) are connected and tab (10) protruding away from the supporting portion (9), said at least one tiltable connecting member (6, 7) being hinged at the tab (10).

6. The rope tensioning device (1) according to claim 3, comprising a leverage (11) interposed between the switch (8) and said at least one tiltable connecting member (6, 7), said at least one tiltable connecting member (6, 7) bringing the leverage (11) to activate the switch (8) when it is tilted beyond the predetermined angle with respect to its working position.

7. The rope tensioning device (1) according to claim 6, wherein the leverage (11) comprises a disk (12) facing said at least one tiltable 15 connecting member (6, 7), said at least one tiltable connecting member (6, 7) being shaped in such a way to contact the disk (12) when it is tilted beyond the predetermined angle with respect to its working position, bringing the leverage (11) to activate the switch (8).

8. The rope tensioning device (1) according to claim 3, wherein the switch (8) is mounted on said at least one tiltable connecting member (6, 7) and the rope tensioning device (1) comprises at least one abutting block (16) which is fixed and arranged in such a way that the switch (8) contacts it when said at least one tiltable connecting member (6, 7) is tilted beyond the predetermined angle with respect to its working position.

9. The rope tensioning device (1) according to claim 1, wherein said lever arm (3) has an elongated development between a first end (3a) and a second end (3b), said lever arm (3) being hinged to the fixed support member (4) at the first end (3a) and to the pulley (2) at an intermediate portion between the first and second end (3a, 3b).

10. The rope tensioning device (1) according to claim 3, wherein said at least one tiltable connecting member (6, 7) and the switch (8) are mutually arranged in such a way that the switch (8) is activated when the position of the pulley (2) exceed from its working range.

11. The rope tensioning device (1) according to claim 3, comprising a further switch (19) facing the first end (3a) of the lever arm (3), said first end (3a) activating the further switch (19) 5 when the position of the pulley (2) exceeds from its working range.

12. Elevator, comprising:
an overspeed governor;
a rope tensioning device (1) according to claim 1;
means for interrupting the functioning of the elevator in response to the detection of a tilt of said at least one tiltable connecting member (6, 7) beyond the predetermined angle with respect to its working position.

13. The rope tensioning device (1) according to claim 2, wherein said means for detecting (8) comprises a switch which is activated when said at least one tiltable connecting member (6, 7) is tilted beyond the predetermined angle with respect to its working position.

14. The rope tensioning device (1) according to claim 2, wherein said lever arm (3) has an elongated development between a first end (3a) and a second end (3b), said lever arm (3) being hinged to the fixed support member (4) at the first end (3a) and to the pulley (2) at an intermediate portion between the first and second end (3a, 3b).

15. The rope tensioning device (1) according to claim 3, wherein said lever arm (3) has an elongated development between a first end (3a) and a second end (3b), said lever arm (3) being hinged to the fixed support member (4) at the first end (3a) and to the pulley (2) at an intermediate portion between the first and second end (3a, 3b).

16. The rope tensioning device (1) according to claim 4, wherein said at least one tiltable connecting member (6, 7) and the switch (8) are mutually arranged in such a way that the switch (8) is activated when the position of the pulley (2) exceed from its working range.

17. The rope tensioning device (1) according to claim 5, wherein said at least one tiltable connecting member (6, 7) and the switch (8) are mutually arranged in such a way that the switch (8) is activated when the position of the pulley (2) exceed from its working range.

18. The rope tensioning device (1) according to claim 6, comprising a further switch (19) facing the first end (3a) of the lever arm (3), said first end (3a) activating the further switch (19) 5 when the position of the pulley (2) exceeds from its working range.

19. Elevator, comprising:
an overspeed governor;
a rope tensioning device (1) according to claim 7;
means for interrupting the functioning of the elevator in response to the detection of a tilt of said at least one tiltable connecting member (6, 7) beyond the predetermined angle with respect to its working position.

20. Elevator, comprising:
an overspeed governor;
a rope tensioning device (1) according to claim 8;
means for interrupting the functioning of the elevator in response to the detection of a tilt of said at least one tiltable connecting member (6, 7) beyond the predetermined angle with respect to its working position.
